(19) United States
(12) Patent Application Publication
(10) Pub. No.: US 2012/0039185 A1
(43) Pub. Date: Feb. 16, 2012

(54) System and Method for Providing Security in a Wireless Communications System

(75) Inventor: Bin Chen, Schaumburg, IL (US)

(73) Assignee: FutureWei Technologies, Inc., Plano, TX (US)

(21) Appl. No.: 13/030,814

(22) Filed: Feb. 18, 2011

Related U.S. Application Data
(60) Provisional application No. 61/372,903, filed on Aug. 12, 2010.

(51) Int. Cl. H04W 12/00; H04W 72/04

(52) U.S. Cl. 370/245; 370/329

(57) ABSTRACT

A system and method for providing security in a wireless communications system are provided. A method for securing information includes producing secured information by applying a sequence to radio resource allocation information; and transmitting the secured information to a communications device. The radio resource allocation information includes a location of a radio resource allocated to a communications device.

This application claims the benefit of U.S. Provisional Application No. 61/372,903, filed on Aug. 12, 2010, entitled “Method for Security in Wireless System,” which application is hereby incorporated herein by reference.

### TECHNICAL FIELD

The present invention relates generally to digital communications, and more particularly to a system and method for providing security in a wireless communications system.

### BACKGROUND

Wireless broadband access systems have changed the way that their users work and enjoy information access. No longer are users of wireless broadband access systems restricted to specific locations with wireline access to information services. In fact, users are free to move wherever they like within a coverage area and still have rapid access to information that they need and/or desire.

Most wireless broadband access systems, notably WiMAX (based on a series of IEEE 802.16 technical standards), Wideband Code Division Multiple Access (WCDMA), High Speed Downlink Packet Access (HSDPA), Long Term Evolution (LTE) and LTE-Advanced (based on technical standards from The Third Generation Partnership Project (3GPP)), and so forth, feature a security function in the air interface to protect traffic and messages. Usually, encryption of some form is used to ensure integrity. Typically, the security function is provided at a Media Access Control (MAC) layer or higher. Unfortunately, for Physical (PHY) layer signaling, for example, radio resource allocation signaling, there is normally no protection.

As an example, in WiMAX (i.e., IEEE 802.16m) radio resource allocation signaling occurs over an allocation map (A-MAP), while in 3GPP LTE radio resource allocation signaling occurs over a physical downlink control channel (PDCCH) and in HSDPA it occurs over a high speed shared control channel (HS-SCCH). The signaling of the radio resource allocation to users (also commonly referred to as mobile stations, users, terminals, and so forth) occurs without encryption, so the information may be detected by unauthorized users. The unauthorized users may then know the location (e.g., time-frequency locations) of the radio resources and intercept transmissions made over the radio resources, thereby compromising the integrity of the communications.

### SUMMARY OF THE INVENTION

These and other problems are generally solved or circumvented, and technical advantages are generally achieved, by example embodiments of the present invention which provides a system and method for securing a wireless communications system.

In accordance with an example embodiment of the present invention, a method for device operations is provided. The method includes producing secured information by applying a sequence to radio resource allocation information, and transmitting the secured information to the communications device. The radio resource allocation information includes a location of a radio resource allocated to a communications device.

In accordance with another example embodiment of the present invention, a method for device operations is provided. The method includes generating securing information, applying the securing information to radio resource allocation information, thereby producing secured information and transmitting the secured information to the communications device. The radio resource allocation information includes a location of a radio resource allocated to a communications device.

In accordance with another example embodiment of the present invention, a communications controller is provided. The communications controller includes an information generate unit, a radio resource allocate unit, a secure unit coupled to the information generate unit and to the radio resource allocate unit, and a transmitter coupled to the secure unit. The information generate unit generates securing information for a communications device, the radio resource allocate unit allocates a radio resource to the communications device, thereby producing radio resource allocation information, the secure unit applies the securing information to the radio resource allocation information, and the transmitter transmits the applied radio resource allocation information to the communications device.

One advantage disclosed herein is that by securing the resource allocation, an unauthorized user's probability of intercepting transmissions may be much lower; and, the integrity of communications may be preserved.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example diagram of downlink resource unit mapping in a WiMAX (IEEE 802.16m) compliant communications system;

FIG. 2a illustrates an example flow diagram of operations in securing radio resource allocation information at a base station, which may be a source of the radio resource allocation information according to example embodiments described herein;

FIG. 2b illustrates an example flow diagram of operations in securing radio resource allocation information at a destination of the radio resource allocation information according to example embodiments described herein;

FIG. 3a illustrates an example flow diagram of operations in securing radio resource allocation information at a base station using a key as securing information according to example embodiments described herein;

FIG. 3b illustrates an example flow diagram of operations in securing radio resource allocation information at a mobile station using a key as securing information according to example embodiments described herein;

FIG. 4a illustrates an example flow diagram of operations in securing radio resource allocation information at a base station using a mapping and/or permutation as securing information according to example embodiments described herein;

FIG. 4b illustrates an example flow diagram of operations in securing radio resource allocation information at a mobile station using a mapping and/or permutation as securing information according to example embodiments described herein;

FIG. 5a illustrates an example flow diagram of operations in securing radio resource allocation information at a base station using multiple signaling channels as securing information according to example embodiments described herein;

FIG. 5b illustrates an example flow diagram of operations in securing radio resource allocation information at a mobile station using multiple signaling channels as securing information according to example embodiments described herein;

FIG. 6a illustrates an example flow diagram of operations in securing radio resource allocation information at a base station using a transformation of the radio resource allocation information as securing information according to example embodiments described herein;

FIG. 6b illustrates an example flow diagram of operations in securing radio resource allocation information at a mobile station using a transformation of the radio resource allocation information as securing information according to example embodiments described herein;

FIG. 7 provides an alternate illustration of a communications device according to example embodiments described herein; and

FIG. 8 provides an alternate illustration of a communications device according to example embodiments described herein.

### DETAILED DESCRIPTION OF ILLUSTRATIVE EMBODIMENTS

The making and using of the current example embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to example embodiments in a specific context, namely a WiMAX compliant communications system that signals resource allocations using an A-MAP. The invention may also be applied, however, to other communications systems that signal resource allocations, such as 3GPP WCDMA/HSDPA, 3GPP LTE, 3GPP LTE-Advanced, and so forth.

Generally, radio resource allocation signaling comprises a transmission of two pieces of data: a first part is the radio resource allocation information (which may include a radio resource index, a MIMO indicator, hybrid automatic repeat requested (HARM) information, and so forth); and a second part is an error check, such as a cyclic redundancy check (CRC) that may be used to check whether the radio resource allocation information signaling was received correctly.

In 3GPP HSDPA, a radio resource allocation information signaling scheme that is similar to that used in WiMAX is used. A Node B (also commonly referred to as a controller, a base station, an enhanced Node B, and so forth) uses a common channel referred to as the HS-SCCH to broadcast radio resource allocation information to User Equipment (UE), also commonly referred to as mobile station, user, terminal, subscriber, and so on, in the form of the radio resource allocation information and a CRC masked with a HSDPA radio network temporary identity (H-RNTI). When the UE receives the radio resource allocation information in the HS-SCCH, the UE may calculate the CRC with its own H-RNTI. If the CRC computed from the UE's H-RNTI produces a correct error check, then the UE received the radio resource allocation information that is intended for it.

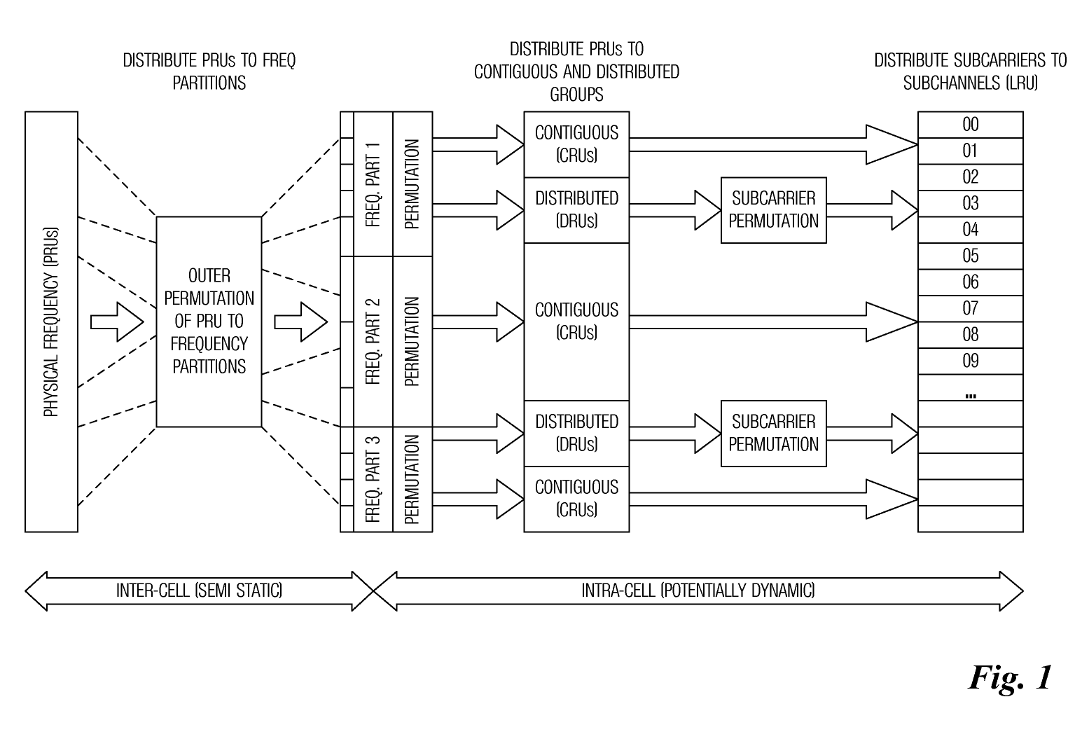

FIG. 1 illustrates a diagram of downlink resource unit mapping in a WiMAX (IEEE 802.16m) compliant communications system. In the WiMAX compliant communications system, a radio resource or similarly, a physical resource, (i.e., a time resource and a frequency resource) may be mapped to a logical resource unit (LRU). In an A-MAP, radio resource allocation information provides LRU information, but not physical resource information.

As shown in FIG. 1, physical resource units (PRUs) may be permuted to a number of frequency partitions (called subcarriers), which may or may not be permuted themselves. The permuted PRUs may be distributed to contiguous groups (thereby forming contiguous resource units (CRUs)) and/or distributed groups (thereby forming distributed resource units (DRUs)). The CRUs and/or the DRUs may then be distributed to subchannels, thereby forming LRUs. The CRUs and/or the DRUs may also undergo permutations prior to being distributed to subchannels.

According to an example embodiment, a variety of physical layer level techniques may be applied to secure the radio resource allocation information during the downlink resource unit mapping that occurs in a WiMAX compliant communications system. Similar physical layer level techniques may be applied to similar mappings occurring in a 3GPP HSDPA, 3GPP LTE, 3GPP LTE-Advanced, and so forth, compliant communications system.

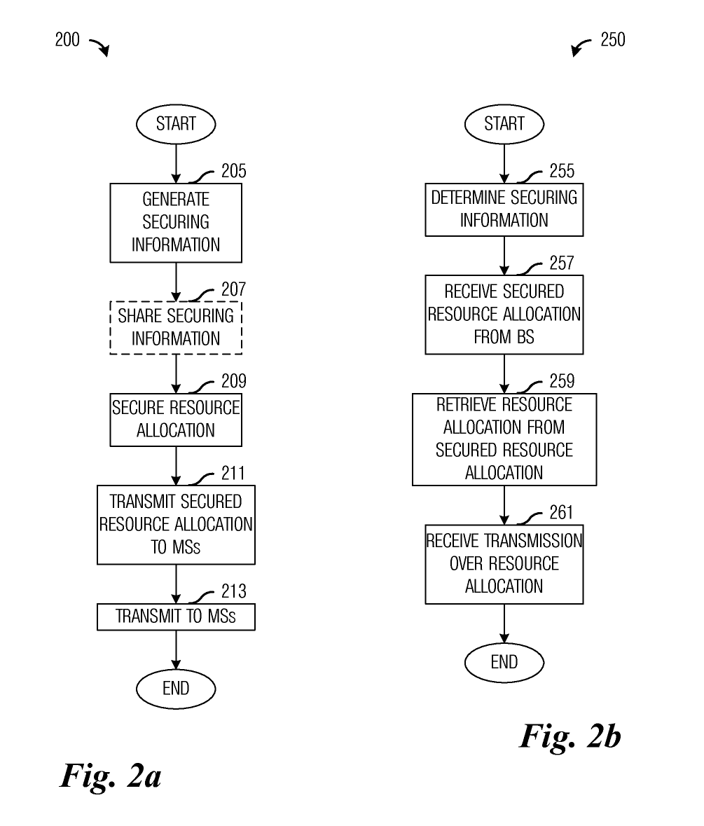

FIG. 2a illustrates a flow diagram of operations 200 in securing radio resource allocation information at a base station, which may be a source of the radio resource allocation information. Operations 200 may be indicative of operations occurring in the base station that is the source of the radio resource allocation information as the base station provides the radio resource allocation information to mobile stations served by the base station. Operations 200 may occur while the base station is in a normal operating mode and has mobile stations to serve.

Operations 200 may begin with the base station generating securing information (block 205). According to an example embodiment, the base station may generate securing information that may be used to secure the radio resource allocation information for each mobile station. The securing information may be unique for each mobile station. According to an alternative example embodiment, the securing information may be unique for a group (or class, type, or so forth) of mobile stations, and if there are multiple groups of mobile stations, then the base station may generate unique securing information for each group (or class, type, or so forth). According to an alternative example embodiment, the securing information may be unique for the mobile stations served by the base station.

Examples of securing information may include: mapping rule(s) used to map resources, such as those used to map downlink resource mapping in a WiMAX compliant communications system; separate signaling channel(s); encryption key(s); hashing function(s); mapping function(s); mapping table(s); permutation rule(s); permutation function(s); translation rule(s); translation function(s); re-calculation rule(s); re-calculation function(s); and so forth.

According to an example embodiment, the base station may make use of unique identifying information for the mobile station, mobile station group, mobile station class, mobile station type, itself, or a combination thereof, to generate the securing information. As an example, if the base station is generating securing information for each mobile station, then the base station may use information, such as the mobile station's identification number, for example, to generate the securing information. Preferably, the base station will make use of information that is unique for the mobile station and will remain constant for the mobile station while the base station continues to serve the mobile station.

The base station may then optionally share the securing information on the mobile station(s) (block 207). According to an example embodiment, the securing information may be transmitted to the mobile stations served by the base station. The securing information for each mobile station may be sent to the mobile station in a unique transmission. As an example, the securing information may be generated by the base station for the mobile station as the mobile station attaches to the base station during an initial startup procedure, a handover, or so forth.

According to an example embodiment, instead of sharing the securing information, the base station may share information related to the securing information, information that corresponds to the securing information, a portion of the securing information, or combinations thereof, with the mobile station.

According to an example embodiment, the securing information may be transmitted to the mobile station in a high layer message, such as a MAC layer message, using securing techniques (e.g., encryption) that may be built into high layer messages. The use of high layer messaging may provide a way to ensure that the securing information arrives at the mobile station with low probability of being intercepted by unauthorized users.

According to an example embodiment, a function used in generating the securing information may be known by the mobile station. Therefore, the mobile station may be capable of generating securing information that matches (or corresponds) to the securing information generated by the base station. Hence, the base station may not need to share the securing information with the mobile station.

The base station may then make its radio resource allocations, thereby generating the radio resource allocation information. The base station may then secure the radio resource allocation information using the securing information (block 209). According to an example embodiment, the base station may secure radio resource allocation information for a specific mobile station by applying or otherwise using securing information for the mobile station. According to an example embodiment, the base station may secure radio resource allocation information for the mobile stations served by the base station by applying the securing information for the mobile station with a function or algorithm.

As an example, the securing information may be applied using a mathematical function, an encryption algorithm, a mapping function, a transformation, a selection algorithm, or so on.

The base station may then send the secured radio resource allocation information to the mobile stations (block 211). According to an example embodiment, the secured radio resource allocation information may be broadcast to the mobile stations. As an example, the secured radio resource allocation information in a WiMAX compliant communications system may be broadcast to the mobile stations over an A-MAP; while in a 3GPP HSDPA compliant communications system, a HS-SCCH may be used to broadcast the secured radio resource allocation information; and in a 3GPP LTE and/or LTE-Advanced compliant communications system, a PDCCH may be used to broadcast the secured radio resource allocation information. According to an example embodiment, the base station may transmit the secured radio resource allocation information to individual mobile stations (or groups, types, or classes of mobile stations depending on a granularity of the securing information) in separate transmissions.

The base station may then transmit to the mobile station(s) at the allocated radio resources (block 213).

FIG. 2b illustrates a flow diagram of operations 250 in securing radio resource allocation information at a destination of the radio resource allocation information. Operations 250 may be indicative of operations occurring in the mobile station that is receiving radio resource allocation information from a base station that is serving the mobile station. Operations 250 may occur while the mobile station is in a normal operating mode and is being served by the base station.

Operations 250 may begin with the mobile station determining securing information that may be necessary to extract radio resource allocation information from secured radio resource allocation information sent by the base station (block 255). According to an example embodiment, the mobile station may receive the securing information, an indication of the securing information, a function of the securing information, a secured version of the securing information, or a combination thereof, from the base station.

According to an example embodiment, the mobile station may be capable of computing the securing information by itself based on a known function matching (or corresponding to) the one used by the base station to generate the securing information and unique information related to the mobile station instead of receiving the securing information from the base station. For example, the known function used by the base station may be indicated to the mobile station during initial startup, handover, or so on, with the base station and the mobile station may then generate the securing information using the known function.

The mobile station may then receive the secured radio resource allocation information from the base station (block 257). According to an example embodiment, the mobile station may receive the secured radio resource allocation information from a broadcast message from the base station. According to an example embodiment, the mobile station may receive the secured radio resource allocation information in a message from the base station that is specifically transmitted to the mobile station.

The mobile station may then retrieve the radio resource allocation information from the secured radio resource allocation information using the securing information that it either received from the base station or computed on its own (block 259). According to an example embodiment, the mobile station may make use of mapping rule(s) used to map resources; separate signaling channel(s); encryption key(s); hashing function(s); mapping function(s); mapping table(s); permutation rule(s); permutation function(s); translation rule(s); translation function(s); re-calculation rule(s); re-calculation function(s); and so forth, to retrieve the radio resource allocation.

Using the radio resource allocation information, the mobile station may then receive a transmission(s) from the base station at the radio resource(s) specified in the radio resource allocation information (block 261).

According to an example embodiment, an encryption key may be used in conjunction with an encryption function to secure the radio resource allocation information. The following description discusses several illustrative embodiments that make use of an encryption key and an encryption function to secure the radio resource allocation information.

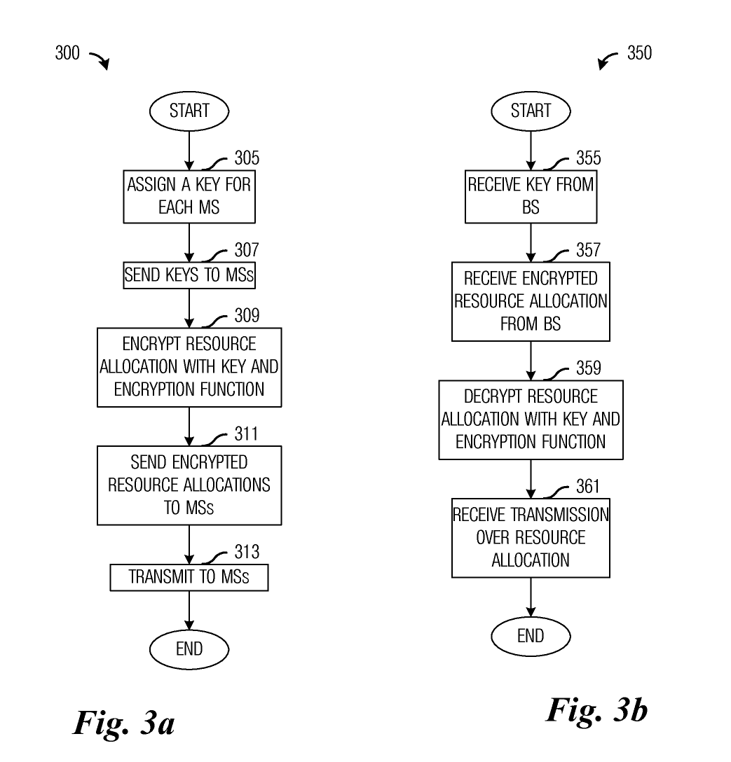

FIG. 3a illustrates a flow diagram of operations 300 in securing radio resource allocation information at a base station using a key as securing information. Operations 300 may be indicative of operations occurring in the base station that is the source of the radio resource allocation information as the base station provides the radio resource allocation information to mobile stations served by the base station. Operations 300 may occur while the base station is in a normal operating mode and has mobile stations to serve.

Operations 300 may begin with the base station assigning a key for mobile stations (block 305). According to an example embodiment, a unique key may be assigned to each mobile station served by the base station. According to another example embodiment, a unique key may be assigned to each group, type, or class of mobile station served by the base station.

According to an example embodiment, the key may be a binary sequence that is N bits long, wherein N is an integer value greater than or equal to one, with larger values of N being preferred since longer keys tend to provide superior security.

The key may then be sent to the mobile station (block 307). As discussed previously, the key may be sent to the mobile station using a high layer message that may include some form of security to help ensure that the key is not available to unauthorized users.

According to an example embodiment, instead of send the key from the base station to the mobile station, the mobile station may be able to generate its own version of the key. The mobile station may generate the key from information consistent with the information used by the base station to generate the key, therefore, ensuring that the key at the mobile station is either the same as the key at the base station or corresponds to the key at the base station. According to an example embodiment, the base station and the mobile station may make use of algorithms such as Master Session KEY (MSK), Pairwise Master Key (PMK), Authentication Key (AK), Traffic Encryption Key (TEK), Cipher-based Message Authentication Code (CMAC Key), and so forth, to generate the key.

With both the base station and the mobile station in possession of the key, the base station may then encrypt radio resource allocation information using the key (block 309). According to an example embodiment, a wide range of encryption functions may be used to encrypt the radio resource allocation information using the key. For example, a binary function, such as a bitwise binary exclusive-OR (XOR) operation, may be used to encrypt the radio resource allocation information. If the radio resource allocation information is longer than the key, then the key may be used to repeatedly encrypt different portions of the radio resource allocation information, while if the radio resource allocation information is shorter than the key, then the radio resource allocation information may be padded until it is of equal length to the key.

For discussion purposes, consider a WiMAX A-MAP, a radio resource indicator is called a resource index and is 11 bits long. A transfer factor (herein referred to as the key) may be 11 bits in length may be used by the base station to mask the resource index. The masking could be done as follows:
resource index XOR key=11100011100 XOR 10011001101=01111010001,
   where, for discussion purposes, the resource index is 11100011100, and the key is 10011001101.

With the masked resource index, the base station creates the radio resource information, and then calculates the CRC for it. The radio resource information and the CRC may then be used to create the A-MAP. Here the resource index is masked before CRC calculation.

According to an example embodiment, it may be possible to mask a subset of the resource index. As an example, consider a resource index that is 11 bits long and a five bit key (or any other number of bits long). The key may be used to mask the five bits (or any other number of bits) of the resource index. The bits being masked may be the least significant bits of the resource index, the most significant bits, or any other subset of bits of the resource index.

According to an example embodiment, instead of masking the resource index before CRC calculation, the resource index may be masked after CRC calculation.

According to an example embodiment, if the entire A-MAP radio resource allocation information is masked, a 40 bit long key is used by the BS to mask the radio resource allocation information, where the entire A-MAP is 40 bits in length. The masking may be performed using a bitwise XOR operation or any of the functions described below.

According to an example embodiment, parts of the resource allocation information other than the resource index may be masked. Furthermore, the entire A-MAP (comprising the resource allocation and the CRC) may be masked.

Instead of a bitwise XOR operation, other operations that provide reversible transformations using the key may be used. Furthermore, in addition to relatively simple logical operations, more complex key-based encryption algorithms may be used, such as Master Session KEY (MSK), Pairwise Master Key (PMK), Authentication Key (AK), Traffic Encryption Key (TEK), Cipher-based Message Authentication Code (CMAC Key), and so forth, algorithms.

Although the discussion focuses on a single key that is used at both the base station to encrypt the radio resource allocation information and at the mobile station to decrypt the secured radio resource allocation information, the embodiments may also be applicable to multi-key encryption, wherein a first key is used to encrypt the radio resource allocation information and a second key is used to decrypt the radio resource allocation information. In a situation wherein a multi-key encryption technique is used to secure the radio resource allocation information, only a key needed to decrypt the secured radio resource allocation information may be sent to the mobile station or alternatively, the key may be generated by the mobile station itself.

For discussion purposes, consider a 3GPP HSDPA compliant communications system, wherein a Node B uses a key to encrypt a whole or a part of radio resource allocation information signaling in a HS-SCCH. As discussed previously, a bitwise XOR operation may be used to encrypt the radio resource allocation information, although any of the functions discussed previously may be used to encrypt the radio resource allocation information.

For discussion purposes, in 3GPP HSDPA, a radio resource indicator called a channelization-code-set information is seven bits in length. Then, a seven-bit key may be used by the Node B to mask the channelization-code-set information. The masking may be as follows:
Original “channelization-code-set information” XOR key
   =1101100 XOR 1001101=0100001
   =transferred “channelization-code-set information”,
      where the “channelization-code-set information” is 1101100, and the key is 1001101.

Using the transferred “channelization-code-set information”, the Node B may create a radio resource information and then calculate a CRC for the radio resource information. The Node B may then create HS-SCCH signaling with the radio resource information and the CRC.

According to an example embodiment, the masking of the “channelization-code-set information” may be performed prior to the CRC calculation. However, the masking may be performed after the calculation of the CRC.

According to an example embodiment, it may be possible to mask a subset of the “channelization-code-set information”. As an example, consider “channelization-code-set information” that is seven bits long and a five bit key (or any other number of bits long). The key may be used to mask the seven bits (or any other number of bits) of the resource index. The bits being masked may be the least significant bits of the resource index, the most significant bits, or any other subset of bits of the resource index.

According to an example embodiment, if the entire HS-SCCH resource allocation signaling is masked, the masking may be performed as described above, but with a longer key. The masking may be performed using a bitwise XOR operation or any of the functions described below.

According to an example embodiment, parts of the HS-SCCH signaling may be masked other than “channelization-code-set information.”

After encrypting the radio resource allocation information, the base station may send the encrypted radio resource allocation information to the mobile station (block 311). According to an example embodiment, if the base station is also allocation radio resources for other mobile stations, the base station may also transmit encrypted radio resource allocation information to the other mobile stations.

The base station may subsequently transmit to the mobile station when the radio resource(s) allocated to the mobile station appear (block 313).

FIG. 3b illustrates a flow diagram of operations 350 in securing radio resource allocation information at a mobile station using a key as securing information. Operations 350 may be indicative of operations occurring in the mobile station that is receiving radio resource allocation information from a base station that is serving the mobile station. Operations 350 may occur while the mobile station is in a normal operating mode and is being served by the base station.

Operations 350 may begin with the mobile station receiving a key from the base station serving the mobile station (block 355). As discussed previously, the key may be sent to the mobile station using a high layer message that may include some form of security to help ensure that the key is not available to unauthorized users. According to an example embodiment, a unique key may be assigned to each mobile station served by the base station. According to another example embodiment, a unique key may be assigned to each group, type, or class of mobile station served by the base station.

According to an example embodiment, instead of receiving the key from the base station, the mobile station may be able to generate its own version of the key. The mobile station may generate the key from information consistent with the information used by the base station to generate the key, therefore, ensuring that the key at the mobile station is either the same as the key at the base station or corresponds to the key at the base station. According to an example embodiment, the mobile station may make use of algorithms such as Master Session KEY (MSK), Pairwise Master Key (PMK), Authentication Key (AK), Traffic Encryption Key (TEK), Cipher-based Message Authentication Code (CMAC Key), and so forth, to generate the key.

The mobile station may then receive encrypted radio resource allocation information from the base station (block 357). The mobile station may then decrypt the encrypted radio resource allocation information to obtain the radio resource allocation information (block 359). According to an example embodiment, a wide range of encryption functions may be used to encrypt the radio resource allocation information using the key. For example, a bitwise exclusive-OR (XOR) operation may be used to encrypt the radio resource allocation information. If the radio resource allocation information is longer than the key, then the key may be used to repeatedly encrypt different portions of the radio resource allocation information, while if the radio resource allocation information is shorter than the key, then the radio resource allocation information may be padded until it is of equal length to the key.

According to an example embodiment, when the mobile station (or user equipment in 3GPP LTE or LTE-Advanced) receives the A-MAP, it will calculate a CRC for the radio resource information and check whether it was received correctly. If the radio resource information was received correctly, the mobile station will re-mask the received resource information using the key to get the resource index, which may be expressed as:
received resource index XOR key=01111010001 XOR 10011001101
   =11100011100=resource index,
      where received resource index is 01111010001, and the key is 10011001101.

According to an example embodiment, if the resource index is masked with the key after the calculation of the CRC, the mobile station may, after receiving the A-MAP, re-mask the received resource index using the key to obtain the resource index, which it may check to determine if it was received correctly.

According to an example embodiment, when the user equipment receives the HS-SCCH signaling, the user equipment may calculate the CRC to determine if the radio resource information was received correctly. The user equipment may then re-mask the received “channelization-code-set information” using the key to obtain the “channelization-code-set information”, which may be as follows:
received “channelization-code-set information” XOR key
   =0100001 XOR 1001101=1101100=“channelization-code-set information”,
      where the “channelization-code-set information” is 1101100, and the key is 1001101.

After obtaining the radio resource allocation information, the mobile station may detect for transmissions at the radio resource(s) specified in the radio resource allocation information to receive transmission(s) from the base station (block 361).

According to an exemplary embodiment, a mapping and/or permutation scheme may be used to secure the radio resource allocation information. The following description discusses several illustrative embodiments that make use of a mapping and/or permutation to secure the radio resource allocation information.

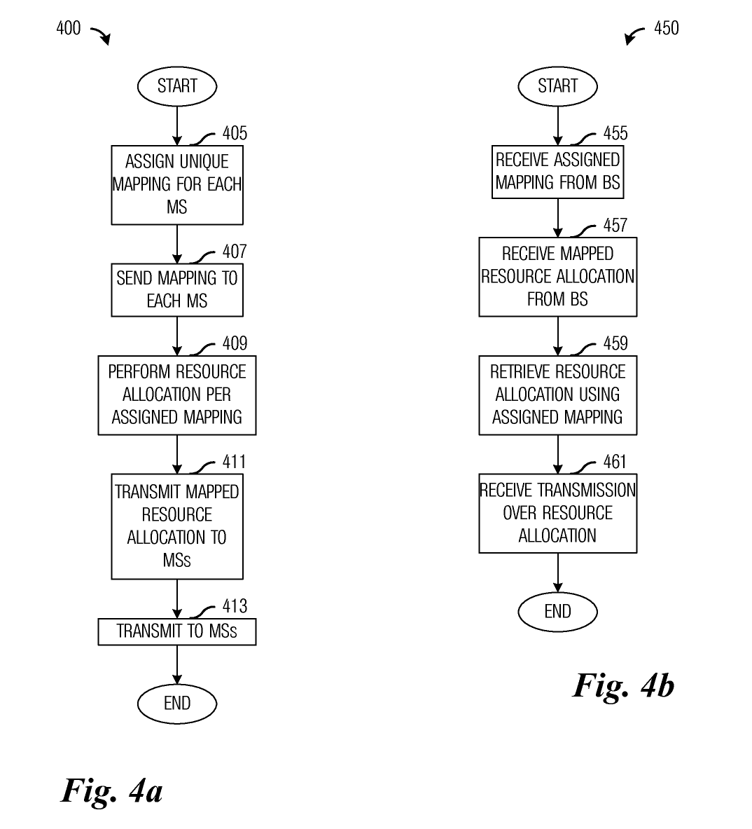

FIG. 4a illustrates a flow diagram of operations 400 in securing radio resource allocation information at a base station using a mapping and/or permutation as securing information. Operations 400 may be indicative of operations occurring in the base station that is the source of the radio resource allocation information as the base station provides the radio resource allocation information to mobile stations served by the base station. Operations 400 may occur while the base station is in a normal operating mode and has mobile stations to serve.

Operations 400 may begin with the base station assigning a mapping and/or permutation scheme for mobile stations (block 405). According to an example embodiment, a unique mapping and/or permutation may be assigned to each mobile station served by the base station. According to another example embodiment, a unique mapping and/or permutation may be assigned to each group, type, or class of mobile station served by the base station.

According to an example embodiment, the unique mapping and/or permutation may be used at the base station to map physical resource units to subcarriers, subcarriers to CRUs and/or DRUs, CRUs and/or DRUs to subchannels (LRUs), PRUs to frequency partitions, and so forth, such as shown in FIG. 1. The unique mapping and/or permutation may specify any or all of the mappings. Collectively, information regarding or about the unique mapping and/or permutation may be referred to as mapping information.

According to an example embodiment, a mapping and/or permutation scheme may specify a mapping and/or permutation of PRUs to LRUs. As an example, a first mapping and/or permutation scheme may specify that PRUs 1 and 2 may be mapped to LRUs 11 and 12 for a first mobile station and PRUs 1 and 2 to LRUs 10 and 11 for a second mobile station.

According to an example embodiment, a mapping and/or permutation scheme may specify a mapping and/or permutation of DRUs and CRUs to LRUs. As an example, a second mapping and/or permutation scheme may specify that DRUs or CRUs 1 and 2 may be mapped to LRUs 11 and 12 for a first mobile station and DRUs or CRUs 1 and 2 may be mapped to LRUs 10 and 11 for a second mobile station.

According to an example embodiment, a mapping and/or permutation scheme may specify a mapping and/or permutation of DRUs and CRUs to PRUs. As an example, a third mapping and/or permutation scheme may specify that DRUs or CRUs 1 and 2 may be mapped to PRUs 11 and 12 for a first mobile station and DRUs or CRUs 1 and 2 may be mapped to PRUs 10 and 11 for a second mobile station.

According to an example embodiment, a mapping and/or permutation scheme may specify a mapping and/or permutation of PRUs and frequency partitions. As an example, a fourth mapping and/or permutation scheme may specify that PRUs 1, 2, and 3 may be mapped to frequency partition 1 and PRUs 4, 5, and 6 may be mapped to frequency partition 2 for a first mobile station and PRUs 1, 2, and 3 may be mapped frequency partition 2 and PRUs 4, 5, and 6 may be mapped to frequency partition 1 for a second mobile station.

The mapping and/or permutation scheme may be sent to the mobile station (block 407). As discussed previously, the mapping and/or permutation scheme may be sent to the mobile station using a high layer message that may include some form of security to help ensure that the key is not available to unauthorized users.

With both the base station and the mobile station knowing the mapping and/or permutation scheme, the base station may secure the radio resource allocation information using the mapping and/or permutation scheme (block 409) and transmit the mapped and/or permuted radio resource allocation information to the mobile station (block 411). The base station may subsequently transmit to the mobile station when the radio resource(s) allocated to the mobile station appear (block 413).

FIG. 4b illustrates a flow diagram of operations 450 in securing radio resource allocation information at a mobile station using a mapping and/or permutation as securing information. Operations 450 may be indicative of operations occurring in the mobile station that is receiving radio resource allocation information from a base station that is serving the mobile station. Operations 450 may occur while the mobile station is in a normal operating mode and is being served by the base station.

Operations 450 may begin with the mobile station receiving a mapping and/or permutation scheme from the base station serving the mobile station (block 455). As discussed previously, the mapping and/or permutation scheme may be sent to the mobile station using a high layer message that may include some form of security to help ensure that the mapping and/or permutation scheme is not available to unauthorized users. According to an example embodiment, a unique mapping and/or permutation scheme may be assigned to each mobile station served by the base station. According to another example embodiment, a unique mapping and/or permutation scheme may be assigned to each group, type, or class of mobile station served by the base station.

The mobile station may then receive secured radio resource allocation information from the base station that has been mapped and/or permuted based on the mapping and/or permutation scheme assigned to the mobile station (block 457). The mobile station may then retrieve the radio resource allocation information from the secured radio resource allocation information using the mapping and/or permutation information received from the base station (block 459). After obtaining the radio resource allocation information, the mobile station may detect for transmissions at the radio resource(s) specified in the radio resource allocation information to receive transmission(s) from the base station (block 461).

According to an exemplary embodiment, a use of multiple signaling channels may be used to secure radio resource allocation information. The following description discusses several illustrative embodiments that make use of multiple signaling channels to secure the radio resource allocation information.

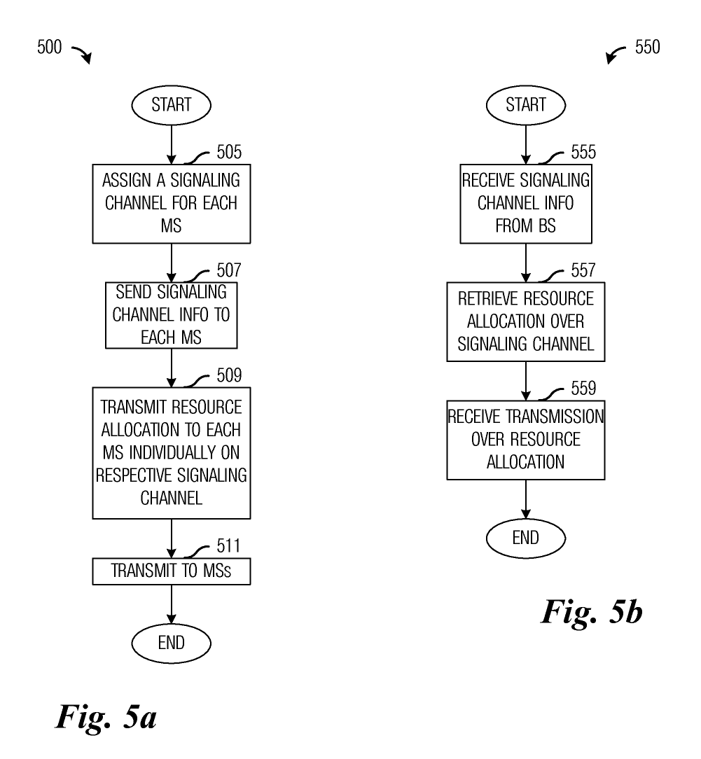

FIG. 5a illustrates a flow diagram of operations 500 in securing radio resource allocation information at a base station using multiple signaling channels as securing information. Operations 500 may be indicative of operations occurring in the base station that is the source of the radio resource allocation information as the base station provides the radio resource allocation information to mobile stations served by the base station. Operations 500 may occur while the base station is in a normal operating mode and has mobile stations to serve.

Operations 500 may begin with the base station assigning a signaling channel for mobile stations (block 505). According to an example embodiment, a signaling channel may be assigned to each mobile station served by the base station, where the signaling channel may be selected out of the multiple signaling channels. According to another example embodiment, a signaling channel may be assigned to each group, type, or class of mobile station served by the base station.

According to an example embodiment, the base station may select a signaling channel out of the multiple signaling channels for each mobile station, where each mobile station is assigned a unique signaling channel.

According to an example embodiment, the base station may select a signaling channel out of the multiple signaling channels for each mobile station, where some mobile stations are assigned unique signaling channels, while some others share signaling channels. For example, mobile stations that are higher priority, higher security level, and so on, may be assigned separate signaling channels, while lower priority, lower security level, and so forth, may be assigned a shared signal channel.

According to an example embodiment, the base station may select a signaling channel out of the multiple signaling channels for each mobile station, where the assigned signaling channel for a mobile station may be unique for the mobile station or the mobile station may need to share the signaling channel with other mobile stations. However, instead of being a permanent or semi-permanent assignment, i.e., indefinite assignment, the assignment of the signaling channel to a mobile station may be for a specified amount of time, or until the base station and/or the mobile station desires to change the signaling channel assignment. According to an example embodiment, the assignment of the signaling channel may be for a random period of time, or until a triggering event occurs. Examples of triggering events may include a specified number of transmissions, a specified number of transmission frames, a specified error rate, or so forth.

Information regarding the assigned signaling channel, such as an indication of where the mobile station will be able to find the signaling channel, may be sent to the mobile station (block 507). Additional information may be sent to the mobile station about the signaling channel, including how long the assignment will persist if the assignment is not a permanent or semi-permanent assignment.

With both the base station and the mobile station knowing the assigned signaling channel, the base station may transmit the radio resource allocation information to the mobile station over the assigned signaling channel (block 509). The base station may subsequently transmit to the mobile station when the radio resource(s) allocated to the mobile station appear (block 511).

According to an example embodiment, in addition to the assigned signaling channel, the base station may apply any of the other techniques discussed herein for securing radio resource allocation information to provide further security for the radio resource allocation information.

FIG. 5b illustrates a flow diagram of operations 550 in securing radio resource allocation information at a mobile station using multiple signaling channels as securing information. Operations 550 may be indicative of operations occurring in the mobile station that is receiving radio resource allocation information from a base station that is serving the mobile station. Operations 550 may occur while the mobile station is in a normal operating mode and is being served by the base station.

Operations 550 may begin with the mobile station receiving a signaling channel assignment from the base station serving the mobile station (block 555). As discussed previously, the signaling channel assignment may be sent to the mobile station using a high layer message that may include some form of security to help ensure that the mapping and/or permutation scheme is not available to unauthorized users. According to an example embodiment, the signaling channel assignment may be made to each mobile station served by the base station. According to another example embodiment, the signaling channel assignment may be assigned to each group, type, or class of mobile station served by the base station.

The mobile station may then receive radio resource allocation information from the base station over the signaling channel assigned to the mobile station (block 557). If the radio resource allocation information is further secured, the mobile station may then retrieve the radio resource allocation information from the secured radio resource allocation information using an appropriate technique for retrieving the radio resource allocation information. After obtaining the radio resource allocation information, the mobile station may detect for transmissions at the radio resource(s) specified in the radio resource allocation information to receive transmission(s) from the base station (block 559).

According to an embodiment, instead of or in addition to making it more difficult for an unauthorized user to detect the radio resource allocation information, it may be possible to provide security for the radio resource allocation information by transforming the radio resource allocation information on a per mobile station basis. The following description discusses several illustrative embodiments that make use of transforms of the radio resource allocation information to secure the radio resource allocation information.

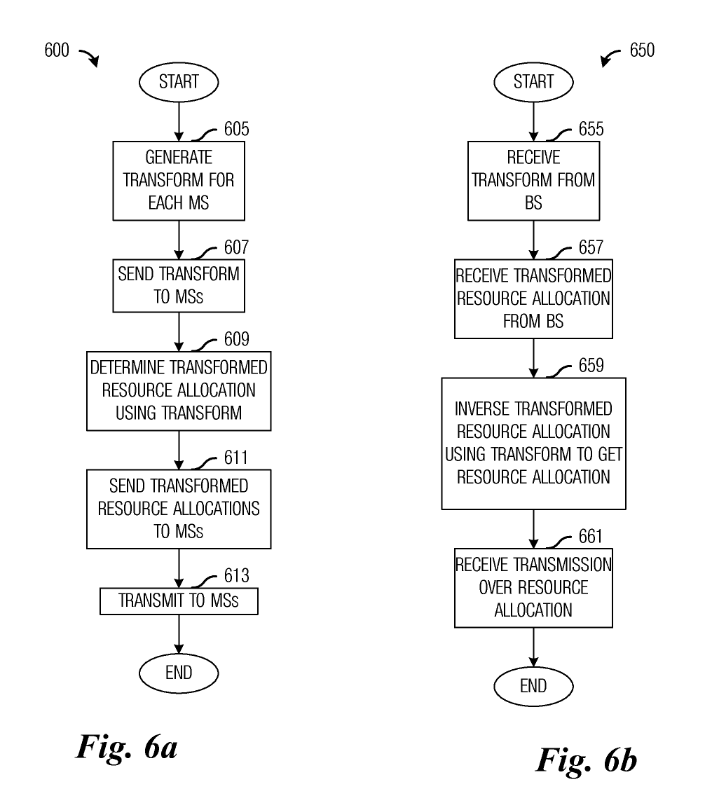

FIG. 6a illustrates a flow diagram of operations 600 in securing radio resource allocation information at a base station using a transformation of the radio resource allocation information as securing information. Operations 600 may be indicative of operations occurring in the base station that is the source of the radio resource allocation information as the base station provides the radio resource allocation information to mobile stations served by the base station. Operations 600 may occur while the base station is in a normal operating mode and has mobile stations to serve.

Operations 600 may begin with the base station generating a transform for the mobile stations (block 605). The transform may be applied to radio resource allocation information for the mobile stations. According to an example embodiment, rather than making it more difficult to intercept the radio resource allocation information, the transformation makes it more difficult for an unauthorized user to make use of the radio resource allocation information once it has been able to intercept the radio resource allocation information. According to an example embodiment, the transform assigned to a mobile station may be unique for each mobile station. According to another example embodiment, the transformation may be assigned to each group, type, or class of mobile station served by the base station.

According to an embodiment, a transform may be used to alter the “channelization-code-set information” used by the base station. As an example, if the “channelization-code-set information” is seven bits in length, then one possible transformation may be described in tabular form as:

| Original “Channelization-code-set | Altered “Channelization-code-set |
|---|---|
| information” | information” |
| 0000000 | 1111111 |
| 0000001 | 1111110 |
| 0000010 | 1111101 |
| 0000011 | 1111100 |
| 0000100 | 1111011 |
| 0000101 | 1111010 |
| 0000110 | 1111001 |
| 0000111 | 1111000 |
| . . . | . . . |
| 1111111 | 0000000 |

Other transformations may be possible, and the transformation illustrated in the table above is an illustrative example and is not intended to be an exhaustive illustration of possible transformations.

According to an embodiment, a transform may be used to alter the resource indicator used by the base station. As an example, if the resource indicator is three bits in length, then one possible transformation may be described in tabular form as:

| Original resource indicator | Altered resource indicator |
|---|---|
| 000 | 111 |
| 001 | 110 |
| 010 | 101 |
| 011 | 100 |
| 100 | 011 |
| 101 | 010 |
| 110 | 001 |
| 111 | 000 |

Other transformations may be possible, and the transformation illustrated in the table above is an illustrative example and is not intended to be an exhaustive illustration of possible transformations.

According to an example embodiment, the transformation may include a re-calculation of the radio resource allocation information. As an example, consider a radio resource indicator in the radio resource allocation information, which may be transformed (e.g., re-calculated) in a number of ways.

According to an example embodiment, a first way to re-calculate the radio resource indicator (discussed in reference to a WiMAX compliant communications systems, but also adaptable to 3GPP LTE and LTE-Advanced compliant communications systems) may be to make use of an 11 bit long resource index. The resource index may range from 0 to 2048 (or 2047). A number may be used by the base station to re-calculate the resource index, where the number may be referred to as a calc-factor. The calc-factor may also range from 0 to 2048 (or 2047). An exemplary embodiment of the re-calculation may be expressed as:

re-calculated resource index=(resource index+calc-factor)Mod 2048.

With the re-calculated resource index, the base station may create the radio resource information and then a CRC, followed by an A-MAP that includes the radio resource information and the CRC. The resource index may be re-calculated before or after CRC calculation.

According to an example embodiment, a second way to re-calculate the radio resource indicator (discussed in reference to a WiMAX compliant communications systems, but also adaptable to 3GPP LTE and LTE-Advanced compliant communications systems) may be expressed as:

re-calculated resource index=(resource index+2048−calc-factor)Mod 2048.

With the re-calculated resource index, the base station may create the radio resource information, and then a CRC, followed by an A-MAP that includes the radio resource information and the CRC. Here the resource index is re-calculated before or after CRC calculation.

According to an example embodiment, a third way to re-calculate the radio resource indicator (discussed in reference to a WiMAX compliant communications systems, but also adaptable to 3GPP LTE and LTE-Advanced compliant communications systems) may be to use a calc-factor that ranges within a specified range, for example, between 0 to 5. The base station may re-calculate using a formula expressed as:
exchange lowest calc-factor bits with highest calc-factor bits of resource index.
   For example, suppose that the resource index is 10101001010, and the calc-factor is three, then the lowest significant three bits (shown as bolded sequence 010) is exchanged with the highest significant the bits (shown as bolded sequence 101), and the re-calculated resource index is 01001001101. With the re-calculated resource index, the base station may create the radio resource information, and then a CRC, followed by an A-MAP that includes the radio resource information and the CRC. Here the resource index is re-calculated before or after CRC calculation.

According to an example embodiment, it may be possible to re-calculate a portion of the resource index (or the resource information) instead of the entire resource index (or the resource information) as shown above. As an example, consider a case with an 11 bit long resource index, a number of bits of the resource index may be re-calculated.

According to an example embodiment, it may be possible to re-calculate the entire A-MAP.

According to an example embodiment, in 3GPP LTE and LTE-Advanced, the radio resource allocation information is referred to as Downlink Control Information (DCI), and the radio resource indicator is referred to as a resource block assignment. The re-calculation techniques discussed previously may be applied to a whole or a part of the DCI, and/or a whole or a part of the resource block assignment.

Information related to the transformation may be sent to the mobile station (block 607). With both the base station and the mobile station knowing the assigned signaling channel, the base station may transform the radio resource allocation information using the transformation (block 609) and transmit the transformed radio resource allocation information to the mobile station (block 611). The base station may subsequently transmit to the mobile station when the radio resource(s) allocated to the mobile station appear (block 613).

According to an example embodiment, in addition to the transformation of the radio resource allocation information, the base station may apply any of the other techniques discussed herein for securing radio resource allocation information to provide further security for the radio resource allocation information.

FIG. 6b illustrates a flow diagram of operations 650 in securing radio resource allocation information at a mobile station using a transformation of the radio resource allocation information as securing information. Operations 650 may be indicative of operations occurring in the mobile station that is receiving radio resource allocation information from a base station that is serving the mobile station. Operations 650 may occur while the mobile station is in a normal operating mode and is being served by the base station.

Operations 650 may begin with the mobile station receiving a transformation to be used to transform the radio resource allocation information from the base station serving the mobile station (block 655). As discussed previously, the transformation may be sent to the mobile station using a high layer message that may include some form of security to help ensure that the mapping and/or permutation scheme is not available to unauthorized users. According to an example embodiment, the transformation may be made to each mobile station served by the base station. According to another example embodiment, the transformation may be assigned to each group, type, or class of mobile station served by the base station.

The mobile station may then receive a transformed radio resource allocation information in a message from the base station (block 657). The mobile station may then retrieve the radio resource allocation information from the secured radio resource allocation information using the transformation (block 659).

According to an embodiment, if the transformation involves a re-calculation of a resource index, then when the mobile station receives the A-MAP, the mobile station may calculate the CRC and check to determine if the A-MAP was received correctly. The mobile station may then re-calculate the received resource index using the calc-factor to obtain the resource index. The calculation performed by the mobile station may be expressed as:

resource index=(received resource index+2048−calc-factor)Mod 2048.

According to an embodiment, if the transformation involves a re-calculation of a resource index, then when the mobile station receives the A-MAP, the mobile station may calculate the CRC and check to determine if the A-MAP was received correctly. The mobile station may then re-calculate the received resource index using the calc-factor to obtain the resource index. The calculation performed by the mobile station may be expressed as:

resource index=(received resource index+calc-factor)Mod 2048.

According to an embodiment, if the transformation involves a re-calculation of a resource index, then when the mobile station receives the A-MAP, the mobile station may calculate the CRC and check to determine if the A-MAP was received correctly. The mobile station may then re-calculate the received resource index using the calc-factor to obtain the resource index. The calculation performed by the mobile station may be expressed as:
exchange lowest calc-factor bits with highest calc-factor bits of resource index.

After obtaining the radio resource allocation information, the mobile station may detect for transmissions at the radio resource(s) specified in the radio resource allocation information to receive transmission(s) from the base station (block 661).

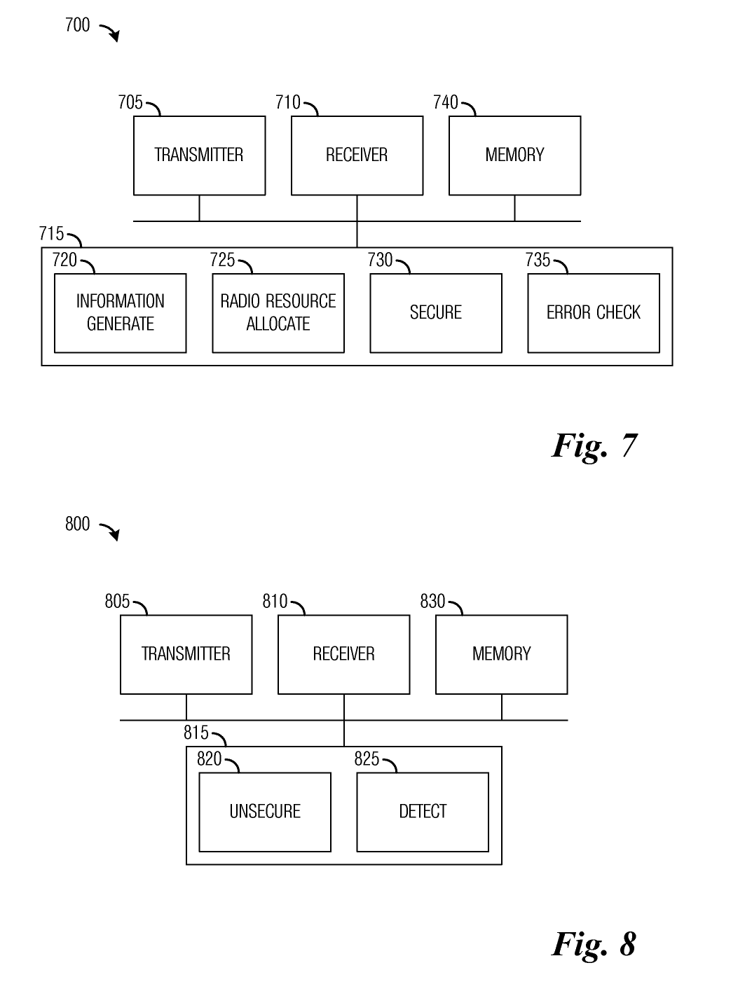

FIG. 7 provides an alternate illustration of a communications device 700. Communications device 700 may be an implementation of a base station. Communications device 700 may be used to implement various ones of the embodiments discussed herein. As shown in FIG. 7, a transmitter 705 is configured to transmit information and a receiver 710 is configured to receive information. An information generate unit 720 is configured to generate securing information, such as a key, a mapping and/or permuting scheme, selecting a signaling channel, a transformation, and so forth. A radio resource allocate unit 725 is configured to allocate radio resource(s) to a mobile station. A secure unit 730 is configured to secure radio resource allocation information using the securing information. An error check unit 735 is configured to generate error checking information. A memory 740 is configured to store information, as well as messages, and so on.

The elements of communications device 700 may be implemented as specific hardware logic blocks. In an alternative, the elements of communications device 700 may be implemented as software executing in a processor, controller, application specific integrated circuit, or so on. In yet another alternative, the elements of communications device 700 may be implemented as a combination of software and/or hardware.

As an example, receiver 710 and transmitter 705 may be implemented as a specific hardware block, while information generate unit 720, radio resource allocate unit 725, and secure unit 730 may be software modules executing in a microprocessor (such as processor 715) or a custom circuit or a custom compiled logic array of a field programmable logic array.

FIG. 8 provides an alternate illustration of a communications device 800. Communications device 800 may be an implementation of a mobile station. Communications device 800 may be used to implement various ones of the embodiments discussed herein. As shown in FIG. 8, a transmitter 805 is configured to transmit information and a receiver 810 is configured to receive information. An unsecure unit 820 is configured to use securing information received from a base station or generated by communications device 800 to extract radio resource allocation information from secured radio resource allocation information, and a detect unit 825 is configured to detect transmissions at radio resources specified in the radio resource allocation information. A memory 830 is configured to store information, as well as messages, and so on.

The elements of communications device 800 may be implemented as specific hardware logic blocks. In an alternative, the elements of communications device 800 may be implemented as software executing in a processor, controller, application specific integrated circuit, or so on. In yet another alternative, the elements of communications device 800 may be implemented as a combination of software and/or hardware.

As an example, receiver 810 and transmitter 805 may be implemented as a specific hardware block, while unsecure unit 820 and detect unit 825 may be software modules executing in a microprocessor (such as processor 815) or a custom circuit or a custom compiled logic array of a field programmable logic array.

The above described embodiments of communications devices 700 and 800 may also be illustrated in terms of methods comprising functional steps and/or non-functional acts. The previous description and related flow diagrams illustrate steps and/or acts that may be performed in practicing example embodiments of the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use (or non use) of steps and/or acts in the recitation of the claims—and in the description of the flow diagrams(s) for FIGS. 2a, 2b, 3a, 3b, 4a, 4b, 5a, 5b, 6a, and 6b—is used to indicate the desired specific use (or non-use) of such terms.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for device operations, the method comprising:
producing secured information by applying a sequence to radio resource allocation information, wherein the radio resource allocation information comprises a location of a radio resource allocated to a communications device; and
transmitting the secured information to the communications device.

2. The method of claim 1, wherein the sequence comprises a binary sequence, and wherein applying a sequence comprises applying the sequence to the radio resource allocation information using a binary function.

3. The method of claim 2, wherein the binary function comprises a binary exclusive-OR function.

4. The method of claim 1, wherein producing secured information comprises:
applying the sequence to the radio resource allocation information, thereby producing the secured information; and
computing an error check for the secured information,
wherein transmitting the secured information comprises transmitting the secured information and the error check.

5. The method of claim 1, wherein producing secured information comprises:
computing an error check for the radio resource allocation information; and
applying the sequence to the radio resource allocation information and the error check, thereby producing the secured information,
wherein transmitting the secured information comprises transmitting the secured information and the error check.

6. The method of claim 1, further comprising transmitting the sequence to the communications device.

7. The method of claim 6, wherein transmitting the sequence comprises transmitting a corresponding sequence that corresponds to the sequence to the communications device.

8. The method of claim 1, wherein the sequence is applied to a subset of the radio resource allocation information.

9. The method of claim 8, wherein the subset is contiguous.

10. The method of claim 8, wherein the subset is discontiguous.

11. A method for device operations, the method comprises:
generating securing information;
applying the securing information to radio resource allocation information, thereby producing secured information, wherein the radio resource allocation information comprises a location of a radio resource allocated to a communications device; and
transmitting the secured information to the communications device.

12. The method of claim 11, further comprising transmitting the securing information to the communications device.

13. The method of claim 11, further comprising transmitting information corresponding to the securing information to the communications device.

14. The method of claim 11, wherein the securing information comprises an encryption key.

15. The method of claim 14, wherein applying the securing information comprises encrypting the radio resource allocation information with the encryption key.

16. The method of claim 11, wherein the securing information comprises mapping information.

17. The method of claim 16, wherein applying the securing information comprises mapping the radio resource allocation information based on the mapping information.

18. The method of claim 11, wherein the securing information comprises a signaling channel.

19. The method of claim 18, wherein transmitting the securing information comprises transmitting the secured information to the communications device over the signaling channel.

20. The method of claim 18, wherein the signaling channel is selected from a plurality of signaling channels.

21. The method of claim 11, wherein the securing information comprises a transform.

22. The method of claim 21, wherein applying the securing information comprises transforming the radio resource mapping information based on the transform.

23. The method of claim 11, wherein the securing information is unique for the communications device.

24. The method of claim 11, wherein the securing information is unique for a plurality of communications devices.

25. A communications controller comprising:
an information generate unit configured to generate securing information for a communications device;
a radio resource allocate unit configured to allocate a radio resource to the communications device, thereby producing radio resource allocation information;
a secure unit coupled to the information generate unit and to the radio resource allocate unit, the secure unit configured to apply the securing information to the radio resource allocation information; and
a transmitter coupled to the secure unit, the transmitter configured to transmit the applied radio resource allocation information to the communications device.

26. The communications controller of claim 25, wherein the securing information comprises a sequence, and wherein the secure unit comprises an exclusive-OR unit applying the sequence to the radio resource allocation information.

27. The communications controller of claim 25, further comprising an error check unit coupled to the radio resource allocate unit, the error check unit configured to generate error checking information.

28. The communications controller of claim 27, wherein the radio resource allocation information is secured prior to generation of the error checking information.

29. The communications controller of claim 27, wherein the error checking information is generated prior to the securing of the radio resource allocation information.
